(19) United States
(12) Patent Application Publication
(10) Pub. No.: US 2007/0280314 A1
(43) Pub. Date: Dec. 6, 2007

(54) INTEGRATED CIRCUIT FOR DRIVING A LIGHT SOURCE

(76) Inventors: Yong-Chan KEH, Seoul (KR); Jin-Wook Kwon, Suwon-si (KR)

Correspondence Address: CHA & REITER, LLC, 210 ROUTE 4 EAST STE 103, PARAMUS, NJ, 07652, US

(21) Appl. No.: 11/627,397

(22) Filed: Jan. 26, 2007

(30) Foreign Application Priority Data
Jun. 1, 2006 (KR) 2006-49388

(51) Int. Cl. H01S 3/13; H01S 3/00

(52) U.S. Cl. 372/38.02; 372/38.07; 372/38.01; 372/29.015

(57) ABSTRACT

An integrated circuit is provided for driving a light source. The light source outputs light. A light receiver receives part of the light output from the light source. In response to a detection current from the light receiver, an automatic power controller adjusts an operating current of the light source. A power converter efficiently supplies power from a power supply to the light source. A modulation signal input unit inputs a modulation signal for modulation of light output power. This circuit structure performs a control operation for constantly maintaining the intensity of light even in a variation in an ambient temperature or deterioration in the light source and also reduces power consumption in the integrated circuit for driving the light source.

### CLAIM OF PRIORITY

This application claims priority under 35 U.S.C. § 119 to an application entitled “Integrated Circuit for Driving a Light Source,” filed in the Korean Intellectual Property Office on Jun. 1, 2006 and assigned Serial No. 2006-49388, the entire contents of which are incorporated herein by reference.

### BACKGROUND OF THE INVENTION

1. Field of the Invention

The present invention generally relates to an integrated circuit for driving a light source, and more particularly to an integrated circuit for driving a light source that can reduce power consumption by performing a control operation for constantly maintaining light output power even in a variation in an ambient temperature or deterioration in the light source and also efficiently transferring power to the light source using pulse width modulation when an operating current is supplied to the light source such that an output voltage of a light receiver for receiving part of light output from the light source is constantly maintained.

2. Description of the Related Art

Up to now, display devices have used laser light sources of red, green and blue due to easy modulation of image signals, color reproduction improvement, and brightness improvement. In particular, when a semiconductor laser is used for a display light source, light output power is varied due to a variation in an ambient temperature or deterioration in a light source, such that light quality and brightness of a display device also deteriorate. Thus, a device for constantly maintaining light output power of a light source, i.e., an automatic power control (APC) circuit, is needed.

A semiconductor laser diode (LD) used for the light source is configured with a package structure of a metal substance such as TO-18 and so on. In this case, an LD chip emits most of a light output of more than 90% in a front direction, and emits a light output of less than about 10% in a rear direction.

Because output power of the LD significantly varies with temperature, it should be able to be constantly maintained on the basis of an electric current detected by a photodiode in order to stabilize the light output power. Further, the photodiode can be mounted in the rear direction of the LD chip so that the photodiode detects the output power of light emitted in the rear direction of the LD chip. A drive circuit with an APC function is used to constantly maintain the output power. A conventional LD drive circuit will be described with reference to a LD drive circuit using a photodiode described in Korean Patent Laid-Open No. 2005-54792.

FIG. 1 is a circuit diagram illustrating a conventional LD drive circuit.

In FIG. 1, for example, when a power supply voltage of 5 V is applied to the LD drive circuit 100, it is stabilized in a resistor-capacitor (RC) circuit 110 in which R1 and C1 are connected in parallel and is supplied to an APC circuit 120. An operation of the APC circuit 120 is as follows.

In the APC circuit 120, regular voltages are supplied to first and second transistors Q1 and Q2 by a breakdown voltage (e.g., 4.3V) of a Zener diode (ZD). At this time, when the LD is in operation, light output power is reduced due to a raised temperature and therefore an electric current Iₘ flowing to the LD is reduced. As the current Iₘ is reduced, both a base current I_{b1} and a collector current I_{c1} of the first transistor Q1 increase.

Thus, a base current I_{b2} and a collector current I_{c2} of the second transistor Q2 increase. Because the current I_{c2} corresponds to an output current I_{OP} of the LD, a light output of the LD increases and also the current Iₘ increases. This operation is repeatedly performed and therefore the APC of the LD is performed.

As described above, the conventional APC circuit 120 controls the electric current by means of the transistor Q2 serially connected to the laser using a power supply voltage Vcc of more than an operating voltage Vop of the laser. Thus, a voltage corresponding to a difference between the power supply voltage and the operating voltage is across the transistor or resistor within the drive circuit and is consumed by heat, such that power consumption increases. Thus, there is a problem in that the LD drive circuit is not suitable for portable laser generators such as a laser pointer and a laser display device.

For example, when a green laser is driven by a lithium-ion battery power supply for a portable device, the operating voltage across the green laser is only 1.8V in the total power supply voltage of 3.7V. In the operation condition of the operating current of 350 mA, only the power of 1.8V×350 mA (=630 mW) in the total power of 3.7V×350 mA (=1295 mW) is applied to the green laser, and the remaining power of 665 mW is consumed by heat within the drive circuit. In this case, the power efficiency is about 50%.

### SUMMARY OF THE INVENTION

The present invention efficiently provides power from a power supply to a light source when an automatic power control function is implemented to control an electric current flowing to the light source using a detection voltage of a light receiver for receiving part of a light output. That is, even when there is a variation in an ambient temperature or deterioration in the light source, the present invention provides power such that light output is constantly maintained and also power consumption is reduced in an integrated circuit for driving the light source.

The present invention also modulates a light output in response to various external modulation signals. That is, when a modulation signal input unit is implemented, analog modulation of various waveforms as well as a simple ON/OFF operation of a light source is performed.

Yet another feature of the present invention is to efficiently provide power from a power supply to a light source in the case where an operating voltage of the light source is higher than a power supply voltage as well as in the case where the operating voltage of the light source is lower than the power supply voltage.

In accordance with an aspect of the present invention, there is provided an integrated circuit for driving a light source in a light source display, comprising: a light source for outputting light; a light receiver for receiving part of the light output from the light source and performing conversion to a current signal; an automatic power controller for performing a control operation to constantly maintain an intensity of the light source in response to the current signal output from the light receiver; and a power converter for performing conversion to an output voltage required by the light source by controlling an external power supply voltage in response to a signal output from the automatic power controller and providing an operating voltage of the light source.

### BRIEF DESCRIPTION OF THE DRAWINGS

The above and other features and advantages of the present invention will be more clearly understood from the following detailed description taken in conjunction with the accompanying drawings, in which:

FIG. 1 illustrates a circuit diagram of a conventional laser diode (LD) drive circuit;

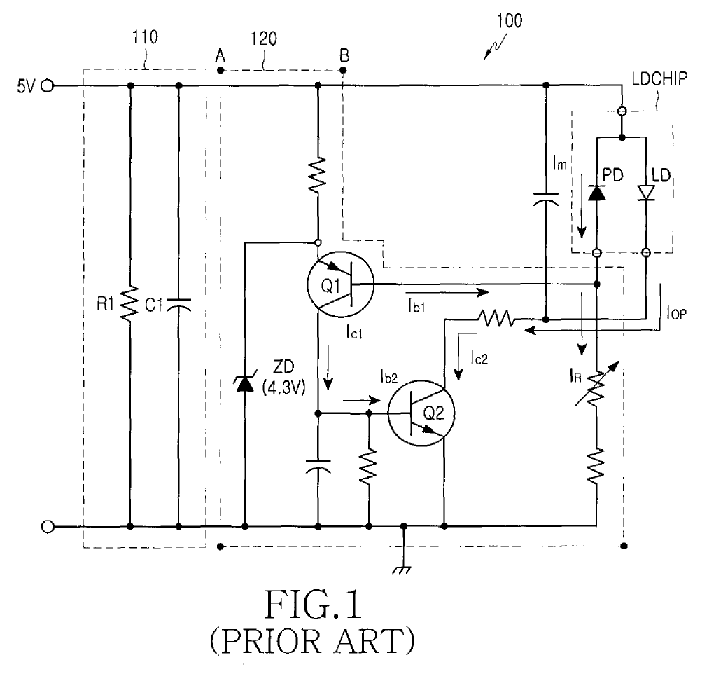

FIG. 2 illustrates a schematic diagram of an integrated circuit for driving a light source in accordance with an exemplary embodiment of the present invention;

FIG. 3 illustrates an internal circuit diagram of an integrated circuit for driving a green LD in accordance with an exemplary embodiment of the present invention;

FIG. 4 illustrates an internal circuit diagram of an integrated circuit for driving a blue LD in accordance with an exemplary embodiment of the present invention; and

FIG. 5 illustrates a waveform diagram of a pulse width modulation operation in accordance with an exemplary embodiment of the present invention.

### DETAILED DESCRIPTION

Exemplary embodiments of the present invention are now described in detail herein below with reference to the accompanying drawings.

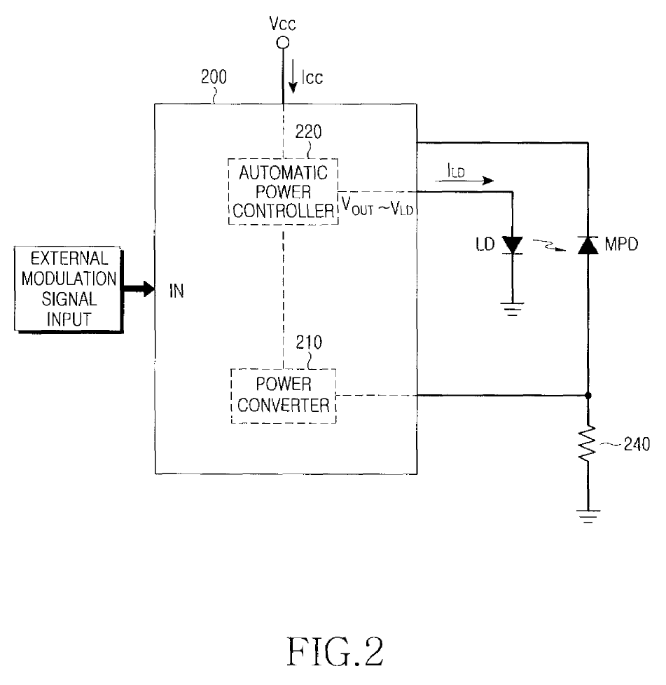

FIG. 2 illustrates a schematic diagram of an integrated circuit (IC) for driving a light source in accordance with an exemplary embodiment of the present invention.

As illustrated in FIG. 2, a light source drive IC 200 in accordance with the exemplary embodiment of the present invention receives part of light output from the light source and performs a control operation for constantly maintaining a light output of the light source in response to an electric current signal detected by a light receiver and a modulation signal input provided by an external image controller (not illustrated). At this time, the external modulation signal is used to improve color reproduction and image brightness and is an analog modulated input signal rather than a simple pulse ON/OFF modulation signal.

The light source is a device for outputting light in the front and rear directions and is arranged with a plurality of light source units. For example, for improved color reproduction of image signals, red, blue and green laser diodes (LDs) are arranged. Each LD emits laser light in proportion to the magnitude of an operating current applied thereto.

In terms of the green laser diode, a semiconductor laser implemented in one chip has not been proposed. A pumped solid-state laser serving as a semiconductor laser conventionally uses a laser for second-harmonic conversion. For example, when an electric current is applied to a semiconductor laser based on gallium arsenide (GaAs), laser light with a wavelength of 808 nm is generated. The neodymium doped yttrium orthovanadate (Nd:YVO4) solid-state laser is pumped with the generated laser light, such that laser light with a wavelength of 1064 nm is generated. Green laser light with a wavelength of 532 nm can be obtained by passing the laser light with the wavelength of 1064 nm to a single crystal for second-harmonic generation (such as potassium titanyl phosphate (KTP), periodically poled lithium niobate (PPLN), or so on).

A light receiver is located in the front direction of an LD chip and is configured with a monitor photodiode (MPD) for detecting part of light. Conventionally, the MPD is driven by reverse bias. Alternatively, the MPD may be driven by forward bias, if needed. In this case, a forward bias voltage is set at a low level of about 0V, since the diode turned on in the forward direction cannot operate as the photodiode if the forward bias voltage is set at a high level of more than 0.5˜0.6V. The forward bias is widely used in a common cathode connection structure in which cathodes of the LD and the MPD are connected. If the MPD is driven by the forward bias in the common cathode connection structure, an additional negative power voltage is not needed.

A green laser module driven by the light source drive IC 200 of the present invention has a structure in which an anode of the LD and a cathode of the MPD are connected. An anode of the MPD is connected to a resistor 240. In this connection structure, the MPD is operated by the reverse bias. According to a detection current supplied from the anode of the MPD, a voltage dropped by the resistor 240 or a feedback voltage is provided to an automatic power controller 210.

The light source drive IC 200 includes the automatic power controller 210 for controlling an operating current such that a light output of the LD is constantly maintained in response to a modulation signal provided from an external image controller (not illustrated) to a modulation signal input unit. In the light source drive IC 200, a type of output light varies with an RGB modulation signal input to the modulation signal input unit. The operating current of each light source differs according to the resistance value of the resistor 240 and the magnitude of the modulation signal.

On the other hand, the light source drive IC 200 includes a power converter 220 for performing conversion to a desired output voltage by controlling a supply of an external power supply voltage Vcc in response to a modulation signal output through the automatic power controller 210. That is, the power is applied to the light source by the power converter 220. To increase conversion efficiency, the power converter 220 operates according to a pulse width modulation control scheme. As the power converter 220 is provided, the power conversion efficiency can be improved up to 80˜90%.

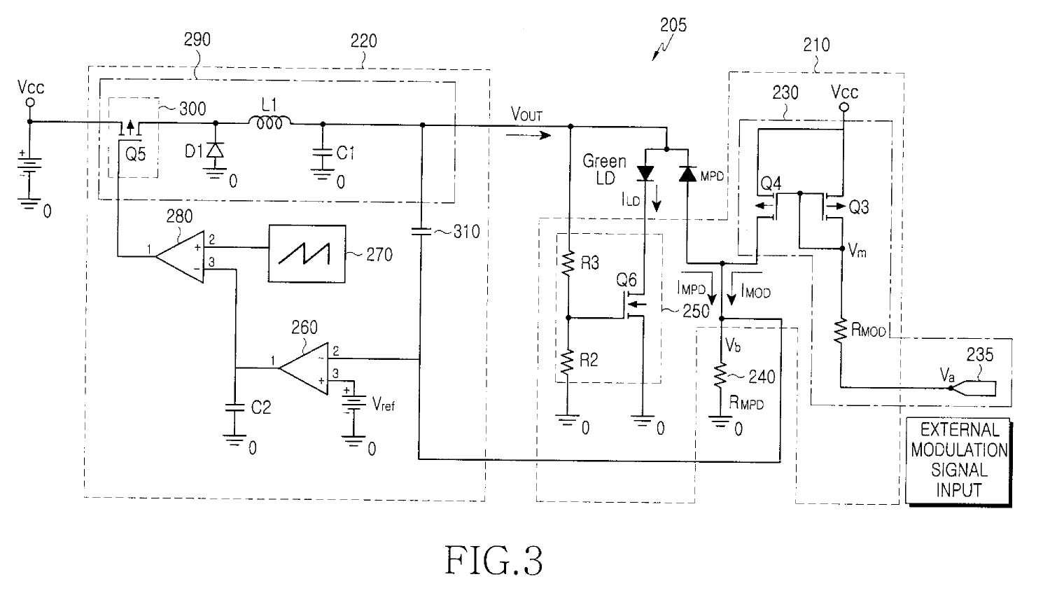

FIG. 3 illustrates an internal circuit diagram of an IC for driving a green LD in accordance with an exemplary embodiment of the present invention. As illustrated in FIG. 3, an automatic power controller 210 of a green LD, that drives IC 205 in accordance with the exemplary embodiment of the present invention, includes a current mirror 230 for outputting a modulation current in response to a green modulation signal input. In the current mirror 230, a modulation signal input unit 235 is connected to a resistor R_{MOD}. The current mirror 230 is provided with P-channel metal oxide semiconductor (PMOS) field effect input and output transistors Q3 and Q4 in which a common gate is connected to the resistor R_{MOD} and a drain. Sources of the transistors Q3 and Q4 are connected to a power supply voltage Vcc.

When a modulation signal is input to the modulation signal input unit 235 in the green LD drive IC 205, the current mirror 230 outputs the modulation current from a drain of the output transistor Q4 in response to the input modulation signal as shown in Equation (1).

I_{MOD}=(Vₘ−Vₐ)/R_{MOD} Equation (1)

A largest value of the output current I_{MOD} can increase until it is equal to an output current I_{MPD} of an MPD. In this case, the generated light is not output. Next, an operation of the current mirror 230 is briefly described when the external modulation signal is an ON/OFF pulse signal.

When Vₐ=0, the input transistor Q3 is turned on and an electric current of (Vₘ−Vₐ)/R_{MOD} flows to the resistor 240 through the output transistor Q4. The current I_{MOD} is conventionally set to be more than the detection current I_{MPD} When Vₐ=0, the feedback current is supplied only from the current I_{MOD} and I_{MPD}=0. In this case, a light output is absent. When Vₐ=Vcc, the input transistor Q3 is turned off. In this case, because I_{MOD}=0, a detection voltage due to only I_{MPD} occurs in the resistor 240. At this time, the light output has a largest value. When Vₐ=Vcc/2, the magnitude of I_{MPD} is similar to that of I_{MOD}. At this time, the light output is reduced to a half of the largest value. In this principle, analog light can be output in response to an analog modulation input.

On the other hand, the detection current I_{MPD} of the MPD for receiving part of light output from the green laser and performing conversion to a current signal is determined by current characteristics of the green laser. That is, an operating current of the laser for obtaining a desired light output is defined by the direct current (DC) characteristics of the LD. When the operating current flows to the laser, the output current I_{MPD} of the MPD corresponding to part of the generated light output is defined.

The current I_{MPD} output from the MPD generates a feedback voltage through the resistor 240. The feedback voltage is compared with a reference voltage V_{ref} preset in a differential amplifier 260 of the power converter 220. When the feedback operation and the automatic power control operation are performed normally, the feedback voltage is equal to the reference voltage of the differential amplifier 260. The resistance value R_{MPD} of the resistor 240 for the feedback circuit operation is computed by Equation (2). The light output of the green laser can be adjusted according to the resistance value R_{MPD} of the resistor 240.

R_{MPD}=V_{ref}/I_{MPD} Equation (2)

In the present invention, the light output is set to a largest value according to the resistance value R_{MPD} of the resistor 240. As an input modulation voltage is varied to a largest value or less, the light output is adjusted.

The automatic power controller 210 is provided with the resistor 240 for generating the feedback voltage V_{b} according to the detection current I_{MPD} output from the MPD for receiving part of light output from the green laser and performing conversion to a current signal. The modulation current I_{MOD} output from the current mirror 230 is added to the detection current I_{MPD} output from the MPD. The resistor 240 drops a voltage. The feedback voltage can be obtained from the dropped voltage. A current source 250 adjusts an operating current to be supplied to the green laser such that the light intensity can be constantly maintained in the green laser according to the feedback voltage.

The automatic power controller 210 performs a control operation for constantly maintaining a laser light output of the green laser by varying an operating current to be applied to the green laser according to the magnitude of a feedback current provided from the laser as in an automatic power control (APC) scheme. In the present invention, the input modulation signal can be used to adjust the light output of the green laser. A modulation current is output in response to an input modulation voltage of the current mirror 230. Feedback is formed such that a sum of the modulation current and the detection current is constantly maintained. As a result, an amount of current flowing to the light source is reduced and an amount of output light is reduced, such that the light output can be adjusted.

On the other hand, the power converter 220 is provided with the differential amplifier 260 for outputting an error signal by comparing the feedback voltage V_{b} output from the automatic power controller 210 with the preset reference voltage V_{ref}, a pulse width comparator 280 for comparing a sawtooth wave signal generated from a sawtooth wave signal generator 270 with the error signal and outputting a pulse width modulation signal in proportion to the magnitude of the error signal, and a buck converter 290 for performing conversion to a desired output voltage by controlling the external power supply voltage Vcc in response to a pulse signal.

The feedback voltage V_{b} generated by the current flowing to the resistor 240 of the automatic power controller 210 is input to an inversion input terminal of the differential amplifier 260, and the preset reference voltage V_{ref} is input to a non-inversion input terminal of the differential amplifier 260. The differential amplifier 260 outputs the error signal corresponding to a positive voltage difference to an inversion input terminal of the pulse width modulation comparator 280. The differential amplifier 260 includes a time constant control capacitor C2 for adjusting a response characteristic of a feedback circuit in response to an output voltage signal of the resistor 240.

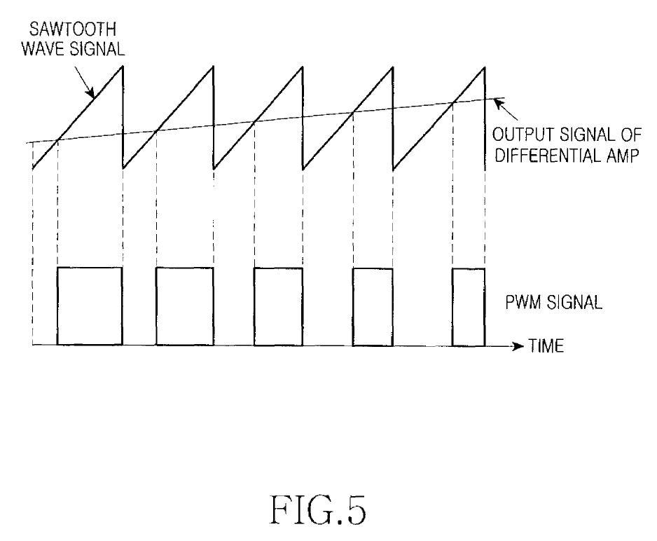

The pulse width modulation comparator 280 receives the error signal through its inversion input terminal and receives a sawtooth wave signal generated from the sawtooth wave signal generator 270 through its non-inversion input terminal. As seen from a waveform diagram of a pulse width modulation operation as illustrated in FIG. 5, the pulse width modulation comparator 280 compares the error signal with the sawtooth wave signal and outputs a pulse width modulation (PWM) signal in inverse proportion to the voltage of the error signal. That is, the width of the pulse signal becomes narrow when the voltage of the error signal increases to drive a switch 300, and a square wave pulse signal with a wide width is output when the voltage of the error signal decreases.

On the other hand, the buck converter 290 includes the switch 300 configured with a PMOS field effect transistor (FET) Q5 corresponding to a switching device for controlling the external power supply voltage Vcc in response to a pulse signal output from the pulse width modulation comparator 280, a diode D1 for allowing the current output from a drain terminal of the PMOS FET Q5 to flow only in one direction, an inductor L1 for generating magnetic induction flux in response to a variation in the current output from the drain terminal of the FET Q5, a capacitor C1 for charging and discharging an electric charge according to a current flow passing through the inductor, and a feed-forward capacitor 310 for preventing oscillation of the feedback circuit.

The switch 300 of the buck converter 290 controls a supply of the external power supply voltage Vcc in response to the pulse signal output from the pulse width modulation comparator 280. The buck converter 290 performs conversion to a preset output voltage required by the light source by controlling the power supply voltage Vcc output from the switch 300. Basically, an output voltage Vout is lower than the power supply voltage Vcc.

The output voltage Vout and the inversion input terminal of the differential amplifier 260 are coupled by the feed-forward capacitor 310, such that an oscillation capable of being generated by a feedback voltage signal of the automatic power controller 210 is prevented. That is, the feed-forward capacitor 310 bypasses a high frequency component of the output voltage and the automatic power controller 210 eliminates the high frequency component, such that the oscillation is prevented.

Next, an operation of the buck converter 290 is described with reference to the automatic power controller 210. When an electric current flows to the green laser light source, laser light is output. Part of the light is detected by the MPD. According to the detection current, a feedback voltage V_{b} is output by the resistor 240. The feedback voltage V_{b} is supplied to the inversion input terminal of the differential amplifier 260. The differential amplifier 260 compares the feedback voltage V_{b} with the reference voltage V_{ref} of its non-inversion input terminal. If the detection current is less than a pre-set value (V_{ref}/R_{MPD}), an output voltage of the differential amplifier 260 is increased and is provided to the inversion input terminal of the pulse width modulation comparator 280. This voltage is compared with the sawtooth wave signal input to the non-inversion input terminal of the pulse width modulation comparator 280. When the output voltage of the differential amplifier 260 increases, an output pulse width of the pulse width modulation comparator 280 decreases. Thus, an OFF time of the switch 300 decreases and an ON time thereof increases, such that the output voltage Vout increases.

When the output voltage increases, an amount of current supplied to the green laser increases and light power of the green laser increases according to the operation of the current source 250. Thus, the detection current of the MPD increases and a feedback operation is performed until the reference voltage V_{ref} is equal to the detection voltage V_{b}. The present invention increases an efficiency of supplying power from the power supply to the light source by combining the automatic power controller 210 with the buck converter 290 operating in response to the pulse width modulation.

To improve the power efficiency, the current source 250 uses an N-channel power MOSFET Q6. When the power MOSFET Q6 is used, an on-resistance value between a drain and a source is only in a range of several ten milliohms to several hundred milliohms. Thus, the voltage drop between the drain and the source can decrease and therefore the power efficiency can increase. The internal power consumption of the power MOSFET Q6 is less than 1/10 of the power consumption of a bipolar power transistor.

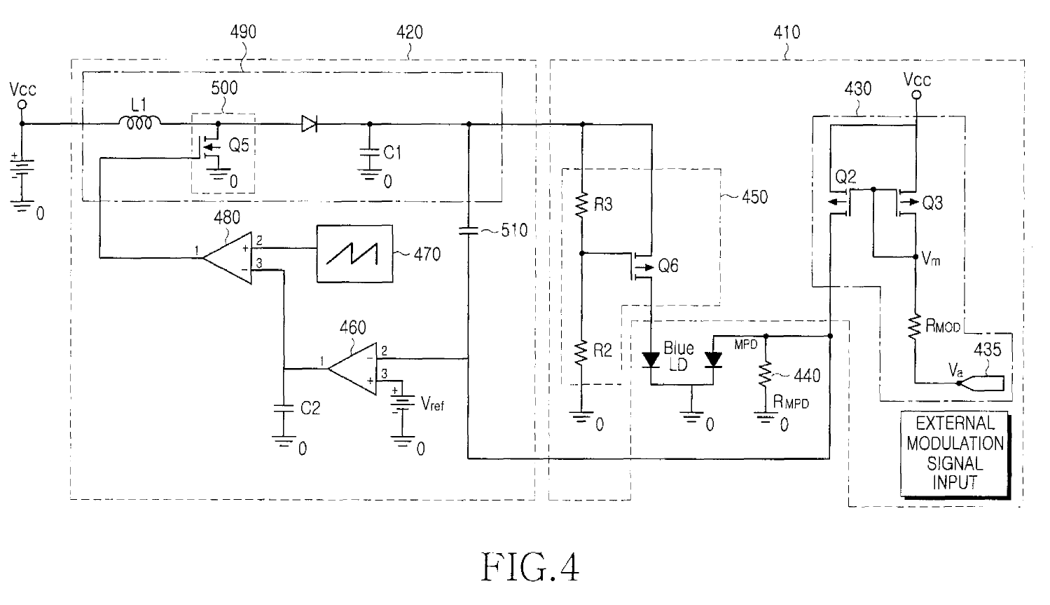

FIG. 4 is an internal circuit diagram illustrating an IC for driving a blue LD in accordance with an exemplary embodiment of the present invention. Because the IC for driving the blue LD is provided with a power converter 220 and an automatic power controller 210, it is similar to the green LD drive IC 205 of FIG. 3. A structure and operation of the blue LD drive IC is now described on the basis of several differences.

An operating voltage of the blue LD is about 5V and uses a lithium-ion battery of a power supply voltage of 3.7V. When a blue LD is used for a portable light source, an additional boost converter 490 is required. This circuit can be implemented by replacing the buck converter 290 of the green LD drive IC 205 with the boost converter 490. A connection structure of the blue LD and an MPD is a common cathode structure. As described above, the MPD is driven by forward bias. Thus, a reference voltage to be supplied to a non-inversion input terminal of a differential amplifier 460 is set to be less than 0.25V. A PMOS transistor used in a current source 450 for supplying an electric current to the light source is different from the NMOS transistor used in the current source 250 for driving the green laser.

Part of laser light output from the blue LD is detected by the MPD. When the detection current flows to a resistor 440, a feedback voltage is generated. When the modulation current generated by an operation of a current mirror 430 receiving an external modulation signal flows to the resistor 440, a feedback voltage is generated. Because a feedback operation is performed such that a sum of the modulation current and the detection current is constantly maintained, the detection current can be adjusted when the modulation current is varied. Thus, the light output of the blue LD can be adjusted.

A feedback voltage generated by the sum of the detection current and the modulation current is provided to the inversion input terminal of the differential amplifier 460. The feedback voltage is compared with the reference voltage of the non-inversion input terminal. If the feedback voltage is less than the reference voltage because the light output of the blue LD is insufficient, an output of the differential amplifier 460 increases. The output of the differential amplifier 460 is provided to the inversion input terminal of a pulse width modulation comparator 480. The pulse width modulation comparator 480 compares the output of the differential amplifier 460 with a sawtooth wave signal of its non-inversion input terminal. As seen from a waveform of a pulse width modulation operation, as illustrated in FIG. 5, the output of the differential amplifier 460 increases and therefore a pulse width of the output signal of the pulse width modulation comparator 480 decreases. The output of the pulse width modulation comparator 480 is input to a gate of a transistor Q5. If a pulse width of a gate input signal decreases, an ON time of the transistor Q5 decreases and therefore an output voltage of the boost converter 490 increases. This output voltage increases an input voltage of the current source 450 and increases an operating current flowing to the blue LD. Thus, the light output of the blue LD increases. The detection current increases in proportion to the increased light output, such that the feedback operation is stopped at an operating point when the feedback voltage is equal to the reference voltage.

As described above, the present invention can output a voltage required by a light source by controlling an external power supply voltage in response to a feedback voltage of a light receiver. Thus, the present invention can control the light source by adjusting an operating current to be supplied to the light source according to a converted output voltage such that the light output is constantly maintained even in a variation in an ambient temperature or deterioration in the light source.

A power converter controls the power supply voltage using a pulse width modulation scheme. Power consumption is reduced inside an IC for driving the light source. When an operating voltage is less or more than the power supply voltage, improved power conversion efficiency can be obtained. According to simulation results of the green laser drive circuit in accordance with the exemplary embodiment of the present invention, 85% of power supplied from the power supply is applied to the light source, the improved power conversion efficiency is 35% more than the existing power conversion efficiency of about 50%.

The light output power of the light source can be adjusted by varying a resistance value of a resistor, such that a largest light output can be set. A variation in the largest light output can be adjusted using an input modulation signal. Various analog modulation operations as well as a pulse operation according to a waveform of an input modulation signal are possible.

An IC and method for driving a light source can be implemented in accordance with the exemplary embodiments of the present invention. Although the exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An integrated circuit for driving a light source in a light source display, comprising:
a light source to output light;
a light receiver to receive at least a part of the light output from the light source and to perform conversion thereof to a current signal;
an automatic power controller to perform a control operation that constantly maintains an intensity of the light output by the light source in response to the current signal output from the light receiver; and
a power converter to perform conversion to an output voltage required by the light source by control of an external power supply voltage in response to a signal output from the automatic power controller and to provide an operating voltage of the light source.

2. The integrated circuit of claim 1, wherein the power converter is provided with a buck converter when the operating voltage of the light source is less than the power supply voltage and is provided with a boost converter when the operating voltage of the light source is more than the power supply voltage.

3. The integrated circuit of claim 1, wherein the power converter comprises:
a differential amplifier to compare an output voltage of the automatic power controller with a preset reference voltage and yield a comparison result and output an error signal based on the comparison result;
a sawtooth wave signal generator that outputs a sawtooth wave signal to be compared with the error signal;
a pulse width modulation comparator that compares the error signal with the sawtooth wave signal and outputs a pulse signal in proportion to a voltage of the error signal; and
a buck converter that performs a conversion to an output voltage required by the light source by controlling a supply of the power supply voltage in response to the pulse signal output by the pulse width modulation comparator.

4. The integrated circuit of claim 3, wherein the differential amplifier comprises:
a time constant control capacitor that adjusts a response characteristic in response to an output voltage signal of the automatic power controller.

5. The integrated circuit of claim 3, wherein the buck converter comprises:
a switch that controls the supply of the external power supply voltage in response to a pulse width modulation signal;
a diode that allows an electric current output from the switch to flow only in one direction;
an inductor that generates magnetic induction flux in response to a variation in the electric current output from the switch;
a capacitor that charges and discharges an electric charge according to a current flow passing through the inductor; and
a feed-forward capacitor, connected between the capacitor and the differential amplifier, that prevents oscillation of a feedback circuit.

6. The integrated circuit of claim 1, wherein the automatic power controller comprises:
a current mirror that outputs a modulation current in response to an external modulation signal; and
a first resistor that drops a voltage according to an electric current acquired by adding the modulation current from the current mirror and an electric current output from the light receiver.

7. The integrated circuit of claim 6, wherein the first resistor sets a largest light output according to a resistance value, such that the light output is adjusted again to a largest light output setting value or less in response to an external modulation signal input.

8. The integrated circuit of claim 6, wherein the automatic power controller further comprises:
a current source that adjusts an operating current supplied from the light source in response to an output voltage of the first resistor.

9. The integrated circuit of claim 8, wherein the current source comprises a metal oxide semiconductor field effect transistor (MOSFET).

10. The integrated circuit of claim 6, wherein the current mirror comprises:
a modulation signal input unit that receives the external modulation signal; and
a second resistor that drops a voltage in response to the modulation signal from the modulation signal input unit,
wherein the power supply voltage is input to sources of P-channel metal-oxide semiconductor (PMOS) input and output transistors in which a common gate is connected to the second resistor and a drain.

11. The integrated circuit of claim 1, wherein the light source comprises red and blue laser diodes and a green laser.

12. The integrated circuit of claim 1, wherein the green laser serves as a semiconductor laser and generates a second harmonic wave by passing pumped solid-state laser light to a single crystal.

13. The integrated circuit of claim 1, wherein the light receiver comprises a monitor photodiode.
